(19) United States
(12) Patent Application Publication
(10) Pub. No.: US 2009/0038640 A1
(43) Pub. Date: Feb. 12, 2009

(54) Multi-stage metal cleaner

(76) Inventors: Francis J. Kestler, Gaylord, MI (US); Nicholas V. Seccia, Gaylord, MI (US); Timothy J Schmidt, Gaylord, MI (US)

Correspondence Address: CHARLES W. HANOR, P.C., P.O. BOX 91319, SAN ANTONIO, TX, 78209, US

(21) Appl. No.: 11/890,873

(22) Filed: Aug. 8, 2007

(51) Int. Cl. B08B 1/04; B08B 13/00

(52) U.S. Cl. 134/6; 134/104.4; 134/115 R; 134/110; 134/104.2

(57) ABSTRACT

The multi-stage coil washer is a system for removing oil and other contaminants from flat metal feed stock for further processing. The system utilizes wash, rinse and dry off stages to remove all of the contaminants and leave a small amount of oil to prevent flash rusting, in the case of a metal feed stock that rusts, and allow for storage. The wash and rinse system use a series of rolls in cartridges, individually motor driven, to clean the metal feed stock comprising of a combination of hard chrome, abrasive embedded non-woven and fibrous rolls. Each cartridge containing a top and bottom roll can be removed. Separate heated wash and rinse fluids are used wash and rinse fluid are separately contained in individual tanks which contain multiple cleaning apparatuses. Each tank cleans the water using micron filters, bacteria filters, magnets, oil separators and centrifuges. The centrifuges remove oil from the water and recycle the cleaned water back into the tank. A mist containment unit prevents mist and steam from escaping in the assembly and the mist collector recycles the recaptured water back into the rinse water tank. The multi-stage metal feed stock washer is an environmentally friendly system designed to continually recycle its wash and rinse water with little waste.

### CROSS-REFERENCE TO RELATED APPLICATIONS

N/A

### STATEMENTS REGARDING FEDERALLY SPONSORED RESEARCH OR DEVELOPMENT

N/A

### REFERENCE TO A MICROFICHE APPENDIX

N/A

### BACKGROUND OF THE INVENTION

1. Field of the Invention

This invention generally relates to a processed metal cleaning or wash system and method for cleaning and drying metal. The cleaning is done after the metal has been un-coiled, and straightened in the case of coil of flat metal sheeting. Processed steel or other flat metal sheet typically contain lubrication oil that is used in the processing and bending of the flat sheet metal and must be removed prior to application of paint. If the flat sheet metal has too much oil remaining the paint will not adhere, however if no oil remains on the flat sheet metal then it may rust in the time period between cleaning and paint application. In the case of steel it is desirable to remove a selected amount of the coating so that the steel does not incur flash rusting and can still be painted.

This invention particularly relates to a processed flat sheet metal wash station and rinse station having multiple interchangeable cartridges that are selectively mounted within the coil wash or rinse station. The rolls; chrome, fibrous or abrasive embedded non-woven within each cartridge collaborate to remove oil, dirt and grime and provide clean and dry metal for the next stage in the process. A unique solution monitoring and cleaning system adds to the system effectiveness. Utilization of easily accessible ambient high speed blow-off knives, mist collectors and a strategically located heated blow-off are important ingredients in the systems overall effectiveness. A multi stage filtration system is an integral part of the overall system design.

2. Description of the Related Art

Some known processed flat sheet metal wash systems include a roller system and an integral tank located below the roller system. The systems utilize upper and lower rolls with the upper rolls mounted directly above the lower rolls. Some current systems utilize three or four upper rolls and three or four lower rolls. There exists in known systems entrance rolls, center rolls and exit rolls. Typically the said systems have a pre-defined gap between the upper and lower rolls. The said systems wash and rinse the un-coiled metal within the same housing, incorporate a hot air blow-off and have mist collection. The said entry and exit rolls are typically a smaller diameter than the center rolls. Each set of center rolls has a combination of a flat sheet metal roll and a squeegee roll on either top or bottom. The said coil washers may have roll lift cylinders operating at a predetermined pressure located above each set of rolls that raise the rolls for maintenance or lower them and apply pressure to the un-coiled metal. The said coil washers have an inlet on one side and an outlet on the other. Between the entrance and exit on either side of the center rolls is a fixed manifold spray system. The spray system may have a plurality of nozzles that deliver the solution used to wash or rinse the un-coiled metal passing through the system. A heated blow-off may be mounted to the exit side of the washer. Both the upper rollers and the lower rollers may be driven and may be operated by a complex chain or belt drive system. An example of prior art includes U.S. Pat. No. 6,814,089 B1.

Known wash systems have some disadvantages. First, some known processed flat sheet metal wash systems (commonly known as coil washers) have six to eight rolls and or brushes all mounted in a single housing. This feature forces coil washer disassembly for maintenance or replacement of the rolls significantly increasing downtime. In addition combining the wash and rinse in a single housing may allow for cross contamination of dirty and clean solution. Moreover the combination of wash and rinse in the same housing may reduce cleaning effectiveness versus having a dedicated wash station. Wash and rinse solution monitoring may be ineffective or not done at all. Wash and rinse solutions used may not be environmentally friendly, may be expensive to use and expensive to dispose of Accessibility to the manifolds may be limited and difficult because they may be mounted directly to the washer housing. The mist collection is virtually ineffective because of air restriction and location. Chain or belt driven rolls have been found in this application to require more maintenance, are noisy and difficult to disassemble when routine maintenance is required. Rolls and brushes are driven with the same drive but wear at different rates; this speed difference stresses and marks the metal traveling through the coil washer. In addition a known flat sheet metal processing washer having many of the less desirable qualities listed above utilizes a combination of rolls and brushes for the purpose of removing scale and inhibiting oxidation. Some other systems utilize volatile organic compounds or aqueous-based detergents that result in contaminated water which must be further processed or disposed of Generally systems that use volatile organic compounds or detergents are not very recyclable in that certain components cannot be reused.

Accordingly the need exists for a self monitoring flat sheet metal processing wash system that improves cleaning using hot water and no chemicals, removes oil and impurities presenting them for recycling, protects the internal plant environment by removing the all fumes and particulate from the air, permits quick accessibility and disassembly of internal components, reduces downtime, and is easily maintained.

### BRIEF SUMMARY OF THE INVENTION

The multi-stage metal washer is an environmentally friendly system and method designed to utilize hot water to remove coatings from uncoiled processed metal feed stock such as steel, aluminum and other sheet metal. Coatings typically include oil or some other corrosion preventative and other debris that can accumulate on processed metal stock. The oil is then extricated from water through high speed centrifuges and recycled, leaving the water approximately 99.0% oil-contamination free. For steel it is often desirable to remove all of the contaminants and leave a small amount of oil to prevent flash rusting, in the case of a metal feed stock that rusts, and allow for storage. The water is also recycled in the process, beginning as reverse osmosis treated water entering the rinse tank and supplying the wash tank. It is practically a closed water system in which the only water leaving the system is through evaporation, further protecting the environment and preventing waste from contaminating water sources. The washed and rinsed metal feedstock maintains a predetermined amount of oil on it which allows for it to be stored for a short period of time before rusting, in the case of steel, but does not contain enough oil to prevent further processing of the metal such as forming and applying paint.

Processed metal feed stock contains oil on its surface due to forming and other processing and is washed through a system comprising a wash stage, rinse stage, and heated dry off stage. Initially, the uncoiled processed metal feed stock enters a set of air knives and proceeds to the wash system that is comprised of cartridges each with two rollers stacked on top of each other made of either hard chrome, fibrous or abrasive material. The system includes spray headers that spray heated water, via wash tank, at a pre-determined pressure on both the upper and lower sides of the flat sheet metal. After the hot water washes the metal feed stock, it proceeds back to the washer tank where oil is removed through filtration and centrifugation prior to reuse. The metal feed stock then proceeds through another set of air knives to prevent contamination of wash fluid and rinse fluid, where it then enters the rinse station. The rinse station is comprised of cartridges comprising two rolls stacked on top of each other made of either chrome or fibrous material. The cartridges also contain spray headers that rinse above and below the washed metal feed stock with hot water drawn from the rinse tank which is approximately 99.9% free of oil. After the rinse, the rinse water is returned to the rinse tank where the remaining oil is removed through filtration and centrifugation. The rinsed metal feed stock proceeds through another set of air knives designed to remove the standing rinse water for recycling and proceeds to a heated blow dry that removes the moisture on the metal feed stock. The liquid runoff and mist created from the air knives is contained through the integral “O” Mist Containment/Removal System that prevents steam and liquid from escaping the system and cycles it to a mist collection unit that allows the steam to be deposited outside the confines of the building and returns the liquid water to the tanks for reuse.

Each cartridge uses individual drive motors driving one or both of the rolls used in the wash and rinse units. The use of individualized motors reduces noise, facilitates easier maintenance and allows repairs of the individual rolls to occur as necessary. The cartridge system allows for introduction of more cartridges to a system if needed. Each cartridge controls the pressure between the two rolls using pneumatic power or machine screw jacks and can adjust at pre-determined pressures to vary between the thicknesses of metal feed stock running through the washing process.

Both the wash and rinse water tanks contain multiple levels of filtration to ensure clean water. Complete in both water tanks are oil separator, high speed centrifuge, screen filters, rare earth magnets, bacterial filtration, carbon monitoring equipment, particle filtration and heating system. The wash tank replenishes water lost to evaporation through a pump system that draws water from the rinse tank. The rinse tank is re-supplied with reverse osmosis treated water.

### BRIEF DESCRIPTION OF THE SEVERAL VIEWS OF THE DRAWINGS

FIG. 1 shows the top-down view over the entire multi-stage flat sheet metal wash system with the service platform removed.

FIG. 2 shows the wash and rinse system with the motors and pipes removed.

FIG. 3 shows the wash and rinse system with air knives with the frame removed to reveal the inner profile.

FIG. 4 shows the heated blow dry system.

FIG. 5 shows the front profile of the wash/rinse system.

FIG. 6 shows the top of the washer tank.

FIG. 7 shows a rear view of the washer tank.

FIG. 8 shows a top side view of the washer tank with the overhead panels removed.

FIG. 9 shows a top view of the rinse tank.

FIG. 10 shows a rear view of the rinse tank.

FIG. 11 shows a top side view of the rinse tank with the overhead panels removed.

### DETAILED DESCRIPTION OF THE INVENTION

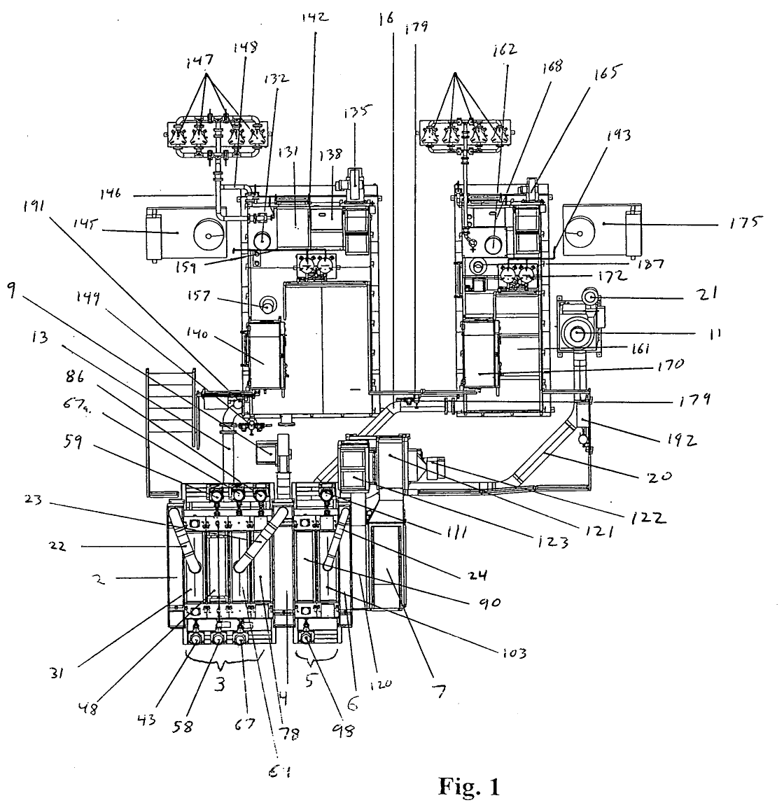

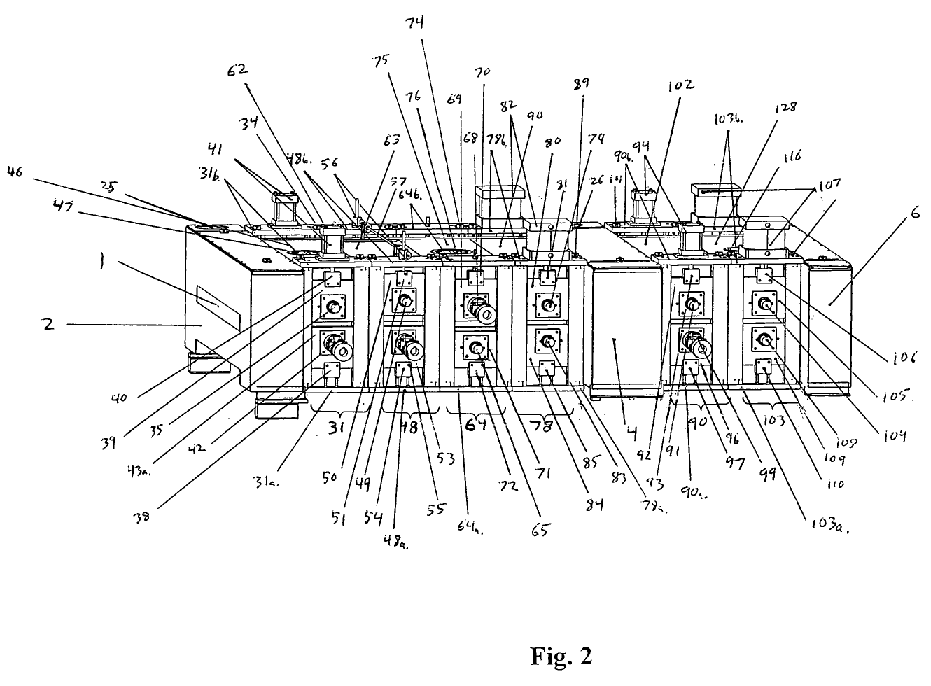

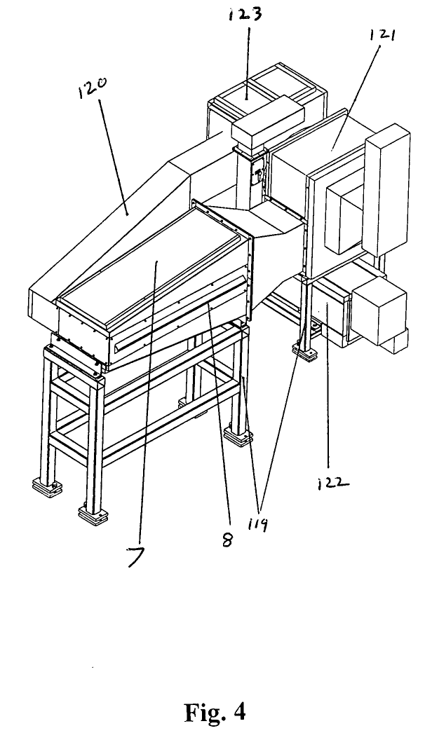

FIG. 1 shows the aerial, top-down view of the entire multi-stage processed flat sheet metal wash system. In the lower left-hand corner is the entrance 1 for the metal feed stock where it flows into the first air knife 2, wash coil stage 3, middle air knife 4, rinse coil stage 5, end air knife 6, and finally exits 8 after proceeding through a heated blow dry 7. The service platform 10 is located behind the entire wash/rinse stage and spans from the entrance to the metal feed stock 1 all the way to the mist collector 11 located beyond the opposite end of the wash/rinse stage. Coil wash/rinse stage begins with an air knife system with air knife located on the top of the metal feed stock. From the air knife, the metal feed stock proceeds to the right in the washer stage that consists of eight rollers (shown on FIG. 2). From the washer stage, the metal feed stock proceeds through an air knife system comprising an air knife located on the top and bottom of the metal feed stock. The metal feed stock further proceeds to the right where it enters a rinse stage comprising four rollers (shown on FIG. 2). From there the metal feed stock proceeds through another air knife, comprising air knives on the top and bottom of the metal feed stock, where it finally proceeds through a heated blow-off 7 that blows heated air diagonally across the metal feed stock. The heated blow off 7 is supplied by the heated blow off stage 19 located directly behind the heated blow off 7. The metal feed stock then exits the system 8 and can be inspected and recoiled for storage or shipping (not shown). The wash/rinse stage is supported by a metal frame 130 (shown on FIG. 4) to allow for piping to be connected from underneath the unit.

Coatings typically include oil or some other corrosion preventative and other debris that can accumulate on processed metal stock. The oil is then extricated from water through high speed centrifuges and recycled, leaving the water approximately 99.0% oil-contamination free. For steel it is often desirable to remove all of the contaminants and leave a small amount of oil to prevent flash rusting, in the case of a metal feed stock that rusts, and allow for storage.

Adjacent to the wash/rinse stage is a service platform 10 with stairwell entrance 12. The metal support platform provides access for operators to the different components of the entire system. The air knifes 2, 4, 6 are supplied with high speed ambient air from the air blower 9 located under the service platform 10 in line with the middle air knife 4. The space underneath the service platform 10 allows multiple metal pipes to travel from the wash/rinse stage to various components of the system.

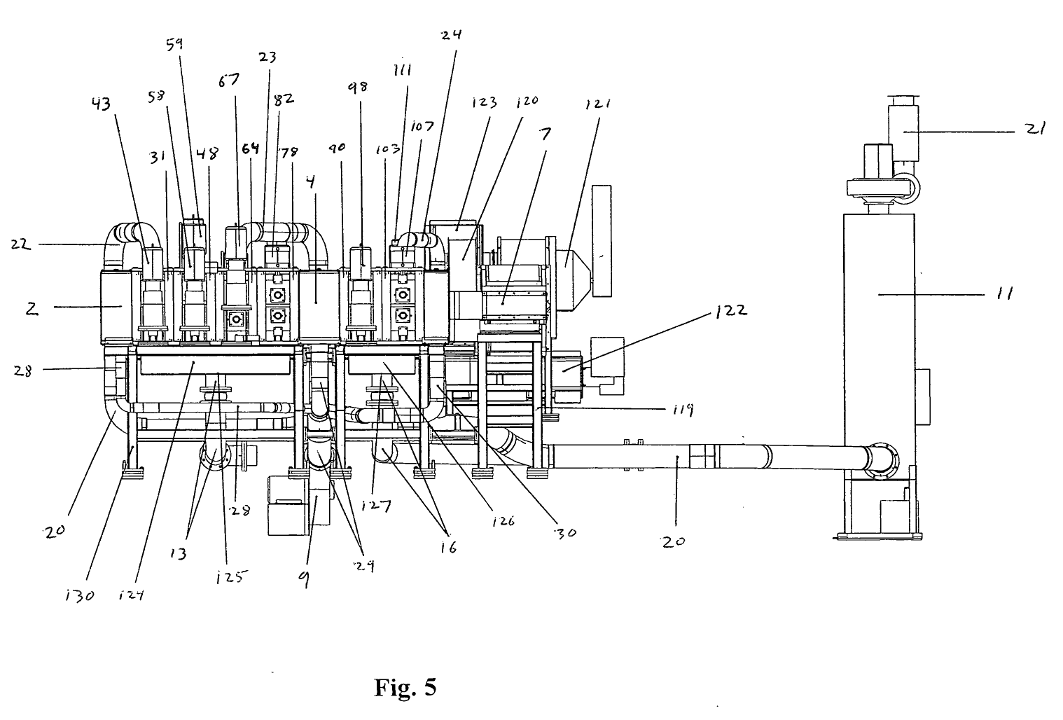

Wash discharge pipe 13 leads from underneath the wash unit 2 perpendicular to the flow of metal feed stock, underneath the service platform 10, and connects to the washer filtration unit 15 via the juncture 14 located on the upper corner along the long face of the wash filtration unit 15, proximal to the air blower 9. Rinse discharge pipe 16 leads from underneath the rinse unit 5, proceeds underneath the service platform 10, parallel to the wash discharge pipe 13 before angling 45 degrees away from the wash discharge pipe 13 and connecting to the rinse filtration unit 18 via juncture 17 located on the upper corner along the long face of the rinse filtration unit 18. Mist collection pipes (shown on FIG. 5) emerge from the top of the wash unit 3 and rinse unit 5 and combine into main mist collection pipe 20 which travels along the base of the wash/rinse stage, under the service platform 10 to the mist collector 11. From the mist collector 11 released mist exits through the exit pipe 21 mounted on mist collector 11.

Located behind the wash stage 3 and the wash manifold 149 is the hydro-carbon testing unit 191. It is mounted to the handrail 190 that surrounds the service platform 10. The hydro-carbon testing unit 192 serves the rinse tank and is located on the handrail 190 located adjacent to the mist collector 11. The hydro-carbon testing unit 191, 192 measures the quantity of the oil and the quality of the water within the tanks. Additionally it can track the oil quantity over a period of time to facilitate maintenance.

Referring to FIG. 2, uncoiled metal feed stock enters the unit at the entry point 1, through the splash guard and enters the first air knife 2. The high speed ambient air is utilized to maintain pressure keeping water from exiting the system and to remove any debris. The uncoiled metal feed stock then enters the first wash cartridge 31 where it is met by an upper 35 and lower hard chrome roll 36. The upper roll 35 is supported on each end by a bearing housing with spherical roller bearings 39. A pneumatic cylinder 41 is mounted on top of the wash cartridge top frame portion 31b and connects to the bearing housing with spherical roller bearings 39 via attachment plate 40. When the pneumatic cylinder actuates, the attachment plate 40, bearing assembly 39, and subsequently the upper roll 35 slide vertically to meet the lower chrome roll 36 and provide a specified pressure. The lower chrome roll 36, mounted directly underneath the upper chrome roll 35, is supported on each side by a bearing housing with spherical roller bearings 43a which is connected to an attachment plate with manual adjusting screws with attachment plate 38 that allow the lower roll 36 to slide vertically to match the roll to pass-line height. The attachment plate with manual adjusting screws 38 is attached to the wash cartridge 31 at bottom frame portion 31a. The lower chrome roll 36 is driven by a motor and speed reducer 43 (shown on FIG. 5) through the drive shaft 42. Each cartridge will use individual drive motors driving one or both of the rolls used in the wash and rinse units. A purpose of the individualized motors is to reduce noise, facilitate easier maintenance and allow repairs of the individual rolls to occur as necessary. The cartridge system also allows for introduction of additional cartridges to a system when needed. Each cartridge allows controlling the pressure between the two rolls using pneumatic power or machine screw jacks and can adjust at pre-determined pressures to vary between the thicknesses of metal feed stock running through the washing process.

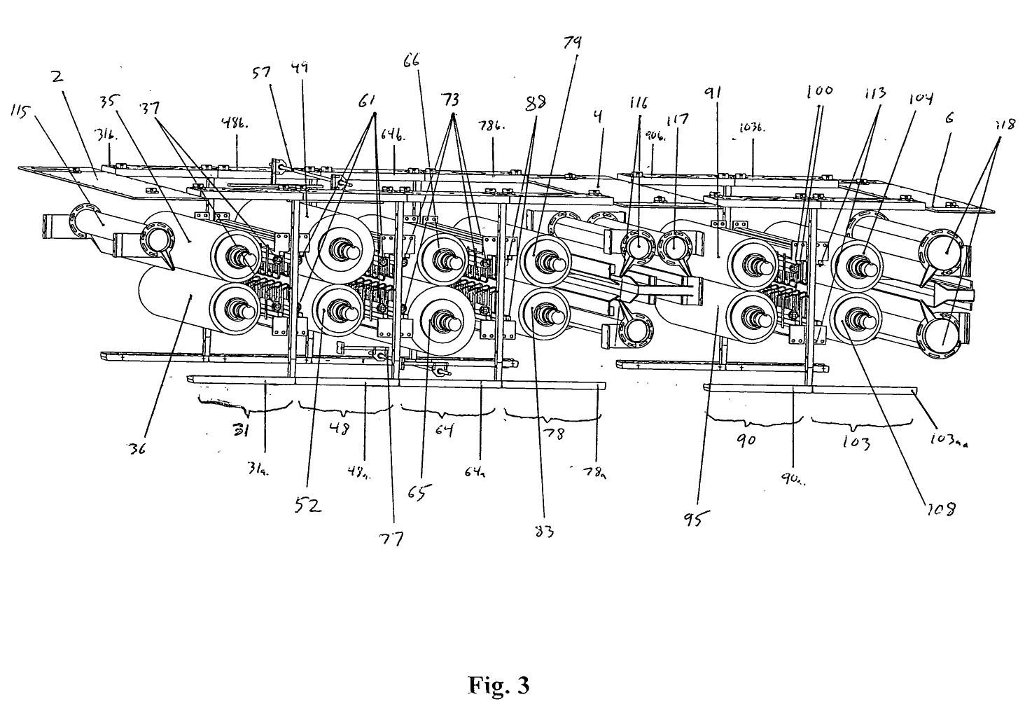

The upper chrome roll 35 is not motor driven but moves along with the uncoiled metal feed stock by friction. Located behind the upper and lower chrome rolls are spray headers 37 (shown on FIG. 3) that dispense hot wash water onto the metal feed stock to assist in removal of the oil. The water is approximately 200° F. The entire first wash cartridge 31 is singularly contained and bolted all four corners to the washer frame (not shown). Once the bolts are removed the lift rings 34 located at each corner can be used to lift the cartridge from the washer frame. This allows the entire cartridge to be removed, complete with both rolls, pneumatic cylinder slides and spray headers for repair or scheduled maintenance. The metal top 46 extends across the entire wash cartridge 31 and prevents mist and liquid from escaping the wash cartridge. Opening 47 located in the middle of the metal top 46 is where the front mist collection pipe 22 connects. Mist generated in the first and second wash cartridges is taken through the front mist collection pipe 22 and connects with main mist collection pipe 20 that leads to the mist collector 11 (shown on FIG. 1, 5).

The metal feed stock is then fed into the second cartridge 48 where the upper roll 49 is an abrasive embedded non-woven roll and is supported on each end by a bearing housing with spherical roller bearings 50 with an attachment plate 51 that allows the upper roll 49 to slide vertically to meet the lower chrome roll 52 and provide a specified pressure. The abrasive or scouring roll may be a non-woven material that acts as an abrasive or scouring material. The roll should be a tough, highly conformable, sharp-cutting, non-woven abrasive for cleaning and finishing surfaces. The attachment plate 51, controlling the upper roll 49, is connected to a jack assembly 56 as a part of the automatic pass line adjustment mounted on top of the second wash cartridge frame 48b on both ends. The shaft 57 connects both the jackscrew assemblies 56 as well as the encoder arrangement (not shown) gear motor (not shown). If adjustment is needed, the automatic pressure adjustment initiates the gear motor that turns the jackscrew assembly allowing the attachment plate 51 to move vertically to adjust the pressure of the roll. The lower chrome roll 52, mounted directly underneath the upper abrasive embedded non-woven roll 49, is supported on each side by a bearing housing with spherical roller bearings 53 which is connected to an attachment plate with manual adjusting screws 54 that allow the lower roll 52 to slide vertically to match the roll to pass-line height. The attachment plate with manual adjusting screws 54 is attached to the wash cartridge 48 at bottom frame portion 48a. The lower roll is a hard chrome roll identical to those used in the first cartridge zone 31 and is driven by a motor and speed reducer 58 through shaft 55. The upper roll 49 is driven by a motor and speed reducer 59 through shaft 60 that is located on the opposite side as the motor and speed reducer that drives the lower roll. When the uncoiled metal feed stock is being fed into the second wash cartridge 48, the upper roll 49 rotates with the metal feed stock helping it thread between the rolls. Once the uncoiled metal feed stock is threaded properly, the upper roll rotates against the direction of the metal feed stock to further facilitate the cleaning process and removal of the deposited oil. The second wash cartridge facilitates the cleaning of the top of the coiled metal feed stock. Spray headers 61 located on either side of the upper and lower rolls spray water that is at 200° F. to help wash off the oil (shown on FIG. 3). The second wash cartridge 48 is singularly contained and bolted on all four corners to the washer frame (not shown) to allow for easy removal. Once the bolts are removed the lift rings 62 located at each corner can be used to lift the cartridge from the washer frame. This allows the entire cartridge to be removed, complete with both rolls, machine screw jacks and spray headers for repair or scheduled maintenance. Metal top 63 encloses the second wash cartridge 48 to prevent mist and liquid from escaping.

The metal feed stock is then fed into the third cartridge 64 which is the same construction as the second wash cartridge 48 but reversed with the chrome roll on the top and the abrasive embedded non-woven roll on bottom. The lower roll 65 is an abrasive embedded non-woven roll and is supported on each end by a bearing housing with spherical roller bearings 71 with an attachment plate 72 that allows the lower roll 65 to slide vertically to meet the upper chrome roll 66 and provide a specified pressure. The lower roll 65 is driven by motor and speed reducer 67a and the upper roll 66 is driven by motor 67a (shown on FIG. 1) through drive shaft 68. The attachment plate 72, controlling the lower roll 65, is connected to a jack assembly as a part of the automatic pass line adjustment mounted on the bottom of the third wash cartridge frame 64a on both ends (not shown). The shaft connects both the jackscrew assemblies as well as the encoder arrangement gear motor (not shown). If adjustment is needed, the automatic pass line adjustment initiates the gear motor that turns the jackscrew assembly allowing the attachment plate 72 to move vertically to adjust the pressure of the roll. The upper chrome roll 66, mounted directly above the lower abrasive embedded non-woven roll 65, is supported on each side by a bearing housing with spherical roller bearings 69 which is connected to an attachment plate with manual adjusting screws with attachment plate 70 that allow the upper roll 66 to slide vertically to match the roll to pass-line height. The attachment plate with manual adjusting screws 70 is attached to the wash cartridge 64 at top frame portion 64b. Spray headers 73 are located on either side of the rolls and dispense hot water onto the metal feed stock (shown on FIG. 3). The lower roll rotates against the direction of the metal feed stock facilitating removal of deposited oil on the underneath of the uncoiled metal feed stock. The third wash cartridge 64 is singularly contained and bolted on all four corners to the washer frame (not shown) to allow for easy removal. Once the bolts are removed the lift rings 74 located at each corner can be used to lift the cartridge from the washer frame. This allows the entire cartridge to be removed, complete with both rolls, machine screw jacks and spray headers for repair or scheduled maintenance. Metal lid 75 encloses the third wash cartridge 64 to prevent liquid and mist from spilling or escaping into the air. Middle mist collection pipe 23 connects to the middle of metal lid 75 at opening 76 and exhausts mist collected in the wash stage and pipes it to main mist collection pipe 20 that then leads to mist collector 11 (shown in FIG. 5). Similar to the second wash cartridge 48, the third wash cartridge contains a an automatic upward pressure adjustment 77 (shown on FIG. 3), located underneath the lower roll 65, complete with a gear motor, jackscrew and encoder arrangement to adjust the down pressure of the roll to ensure proper cleaning of the uncoiled metal feed stock as it is washed.

The metal feed stock then proceeds into the fourth and final washer cartridge 78 comprised of two identical fibrous rolls that work to remove excess liquid from both sides of the metal feed stock. The upper roll 79 is supported on each end by a bearing housing with spherical roller bearings 80. A pneumatic cylinder 82 is mounted on the top frame portion 78b and connects to the bearing housing with spherical roller bearings 80 via attachment plate 81. When the pneumatic cylinder actuates, the attachment plate 81, bearing assembly 80, and subsequently the upper roll 79 slide vertically to meet the lower fibrous roll 83 and provide a specified pressure. The lower fibrous roll 83, mounted directly underneath the upper fibrous roll 79, is supported on each side by a bearing housing with spherical roller bearings 84 which is connected to an attachment plate with manual adjusting screws with attachment plate 85 that allow the lower roll 83 to slide vertically to match the roll to pass-line height. The attachment plate with manual adjusting screws 85 is attached to the wash cartridge 78 at bottom frame portion 68a. The lower fibrous roll 83 is driven by motor 86 through drive shaft 87 (shown in FIG. 1). Spray headers 88 are located preceding the fibrous rolls (shown on FIG. 3). The fourth wash cartridge 78 is singularly contained and bolted on all four corners to the washer frame (not shown) to allow for easy removal. Once the bolts are removed the lift rings 89 located at each corner can be used to lift the cartridge from the washer frame. This allows the entire cartridge to be removed, complete with both rolls, pneumatic cylinder slides and spray headers for repair or scheduled maintenance. The metal lid 90 spans across the cartridge and encloses it keeping the liquid and mist from escaping.

The uncoiled metal feed stock then exits the fourth wash cartridge 78 and enters the second air knife 4 that contains jets of air on both the top and bottom of the metal feed stock (shown in FIG. 3). The purpose of this air knife is to prevent cross contamination between the wash fluid and the rinse fluid.

The uncoiled metal feed stock then enters the entry rinse cartridge 90 where it is met by an upper 91 and lower hard chrome roll 95. The upper roll 91 is supported on each end by a bearing housing with spherical roller bearings 92. A pneumatic cylinder 94 is mounted on top frame portion 90b and connects to the bearing housing with spherical roller bearings 92 via attachment plate 93. When the pneumatic cylinder actuates, the attachment plate 93, bearing assembly 92, and subsequently the upper roll 90 slide vertically to meet the lower chrome roll 95 and provide a specified pressure. The lower chrome roll 95, mounted directly underneath the upper chrome roll 91, is supported on each side by a bearing housing with spherical roller bearings 96 which is connected to an attachment plate with manual adjusting screws with attachment plate 97 that allow the lower roll 95 to slide vertically to match the roll to pass-line height. The attachment plate with manual adjusting screws 97 is attached to the rinse cartridge 90 at bottom frame portion 90a. The lower chrome roll 95 in the entry rinse cartridge 90 is driven by a motor and speed reducer 98 through the drive shaft 99 (shown in FIG. 5). The upper chrome roll 91 is not motor driven by moves along with the uncoiled metal feed stock. Located behind the upper and lower chrome rolls are spray headers 100 that dispense hot rinse water onto the metal feed stock to assist removal of oil (shown on FIG. 3). The water is approximately 160° F. The entire entry rinse cartridge 90 is singularly contained and bolted all four corners to the rinse frame (not shown). Once the bolts are removed the lift rings 101 located at each corner can be used to lift the cartridge off the rinse frame. This allows the entire cartridge to be removed, complete with both rolls, pneumatic cylinder slides and spray headers for repair or scheduled maintenance. Metal lid 102 encloses entry rinse cartridge 90 and prevents mist and liquid from escaping.

The metal feed stock then proceeds into exit rinse cartridge 103 comprised of two identical fibrous rolls that work to remove excess liquid from both sides of the metal feed stock. The upper roll 104 is supported on each end by a bearing housing with spherical roller bearings 105. A pneumatic cylinder 107 is mounted on the top frame portion 103b and connects to the bearing housing with spherical roller bearings 105 via attachment plate 106. When the pneumatic cylinder actuates, the attachment plate 106, bearing assembly 105, and subsequently the upper roll 104 slide vertically to meet the lower fibrous roll 108 and provide a specified pressure. The lower fibrous roll 108, mounted directly underneath the upper fibrous roll 104, is supported on each side by a bearing housing with spherical roller bearings 109 which is connected to an attachment plate with manual adjusting screws with attachment plate 110 that allow the lower roll 108 to slide vertically to match the roll to pass-line height. The attachment plate with manual adjusting screws 110 is attached to the rinse cartridge 103 at bottom frame portion 103a. The lower fibrous roll 108 is driven by motor 111 through drive shaft 112 (shown on FIG. 5). A spray header 113 is located preceding the fibrous rolls (shown on FIG. 3). The exit rinse 103 is singularly contained and bolted on all four corners to the rinse frame (not shown) to allow for easy removal. Once the bolts are removed the lift rings 114 located at each corner can be used to lift the cartridge off the rinse frame. This allows the entire cartridge to be removed, complete with both rolls, pneumatic cylinder slides and spray headers for repair or scheduled maintenance. Metal lid 128 encloses the exit rinse cartridge 103 and prevents mist and liquid from escaping the unit. Connection 116 located in the middle of metal lid 128 is where end mist collection pipe 24 connects to the exit rinse cartridge 103 and collects the mist generated by the rinse stage (shown on FIG. 5). The end collection mist pipe 24 leads to the end air knife 6 before connecting with main mist collection pipe 20 (shown on FIG. 5).

Referring to FIG. 3, the interior of the wash, rinse and air knife system is exposed. The uncoiled metal feed stock enters into front air knife 2 that consists of one air knife that extends the width of the metal feed stock and blows high speed ambient temperature onto the top of the metal feed stock through air knife 115. The middle air knife 4, located between the wash stage 2 and rinse stage 4, utilizes a pair of air knives 116 that extend the width of the metal feed stock and face towards the fourth wash cartridge 78. The pair consists of an air knife that faces the top of the metal feed stock and an air knife that faces the bottom of the metal feed stock but angled towards the fourth wash cartridge 78 to blow any wash liquid back within the wash housing and to prevent liquid from the wash stage contaminating the rinse stage. The middle air knife 4 also contains an air knife 117 that is located on top of the metal feed stock and blows towards the entry rinse cartridge 90 to maintain pressure and prevent rinse liquid from escaping the rinse stage. The end air knife 6, located after the rinse stage, contains a pair of air knives 118 facing the exit rinse cartridge with an air knife mounted for the top of the metal feed stock and an air knife mounted for the bottom of the metal feed stock. These air knives 118 prevent rinse liquid from escaping the rinse stage and removes standing water on the metal feed stock before it enters the heated blow dry 7.

The spray headers 37, 61, 73, 88, 100, 113 are all designed the same with nozzles equally dispersed along the header. The header extends the width of the metal feed stock and allows for even distribution of spray water along the metal feed stock. Each cartridge contains an upper and lower header to spray the upper and lower sides of the uncoiled metal feed stock respectively. The first wash cartridge 31 has one pair of spray headers 37 which are located directly behind the upper and lower rolls. The second wash cartridge 48 contains two pairs of spray headers 61 with the first set located preceding the rolls and the second set located after the rolls. The third wash cartridge 64 has two pairs of spray headers 73 arranged in the same manner as the second wash cartridge 48. The fourth wash cartridge 78 contains only one pair of spray headers 88 located directly preceding the fibrous rolls. The entry rinse cartridge 90 utilizes one pair of spray headers 100 located after the chrome rolls and the exit rinse cartridge utilizes one pair of spray headers 113 located preceding the fibrous rolls.

The wash spray headers 37, 61, 73, 88 utilize wash water from the wash filtration unit 15 via the wash fluid manifold 149 that is heated to approximately 200° F. and contains approximately 1 percent of oil contamination (shown on FIG. 1). Typically the spray headers dispense approximately 250 gallons per minute onto the metal feed stock. The rinse spray headers 100, 113 utilize rinse water from the rinse filtration unit 18 via the rinse fluid manifold 179 that is heated to approximately 160° F. and contains approximately 1/10th percent of oil contamination (shown on FIG. 1). Typically the rinse spray headers dispense rinse fluid at a rate of 150 gallons per minute.

Referring to FIG. 4, the frame 119 supports the heated blow dry stage 19 and air knives 7. The uncoiled metal feed stock proceeds directly from the end air knife 6 (shown on FIG. 1) into the recirculation duct 120 and into the heated blow dry air knife plenum 7. When the system is operating the blower fan 121 forces air into the air knife plenum 7 where it is then re-circulated through duct 120 into the mixing box 123. Mixing box 123 has a filtered fresh air inlet and mixes the fresh air with the re-circulated air. Located underneath the blower fan 121 is the natural gas burner unit 122 that heats the air in the mixing box 123. The blower fan 121 uses the heated air from mixing box 123 and forces it into the air knife plenum 7 where the heated air is blown on both sides of the metal feed stock to remove moisture.

Referring now to FIG. 5, the washer frame 124 and rinse frame 126 are constructed of metal feed stock plate, structural stainless metal feed stock tubing, insulation and metallic sheet metal. All mounting surfaces are machined to insure proper fit and alignment. The head-section is enclosed in aluminum, with covers on top and sides of the unit. Splash guards are positioned at the material entry and exit points. All machined surfaces are nickel-plated. The housing utilizes multiple mating members' guides and supports several interchangeable cartridges. The wash and rinse frames are supported by a metal frame 130. The wash frame 124 is located underneath the four wash cartridges and contains a drain 125 located in the middle of it. The design of the wash frame 124 allows all wash fluid delivered via the spray headers to flow into the drain 125 and into the wash drain pipe 13. The wash drain pipe 13 flows directly down before curving 90° perpendicular to the wash stage. The wash drain pipe then proceeds along before making another 90° curve parallel to the wash stage in the direction of the flow of metal feed stock and connects to the wash filtration 15 (shown on FIG. 1). The rinse frame 126 is located underneath the two rinse cartridges and contains a drain 127 located in the middle of it. The design of the rinse frame 126 allows all rinse fluid delivered via the spray headers to flow into the drain 127 and into the rinse drain pipe 16. The rinse drain pipe 16 extends straight down out of the rinse frame 126 before curving 90° perpendicular to the rinse stage. The rinse drain pipe 16 then proceeds along before making another 90° curve parallel to the rinse stage in the direction of the flow of metal feed stock and connects to the rinse filtration 18 (shown on FIG. 1).

The “O” Mist Containment/Removal System includes the ambient high-speed blow off air knives 2, 4, 6 as well as the pipe system that contains the mist and routes the liquid to the mist collector 1. The ambient high-speed blow-off air knives are supplied by air through the high speed air blower 9 located underneath the service platform 10 and behind the wash/rinse stage. From the high speed air blower, a pipe 29 extends underneath the middle air knife 4 before making a 90° curve to enter the middle air knife 4 from its front underside. Air travels from this pipe 29 and into the blower 115 (shown in FIG. 3). Before the main handler pipe 29 makes the 90° curve into the middle air knife 4, a smaller pipe 28 connects with it and curves 45° towards the side of wash stage and then connects with the front underside of the front air knife 2. Air from this pipe 28 supplies the blowers 116, 117 located in the front air knife 2 (shown on FIG. 3). A second pipe 30 emerges from the main air handler pipe 29 prior to the front air handler pipe 28. This pipe is larger than the front air pipe 28 but smaller than the main air pipe 29 and angles 45° towards the side of the rinse stage before curving 90° and joining the end air knife 6 at its front underside. The end air pipe 30 supplies the air to the blowers 118 in the end air knife 6 (shown in FIG. 3).

The front mist collector pipe 22 extends from the middle of metal lid 46 at opening 47 (shown on FIG. 2) proceeds to connect with the front air knife 2 on top rear side. The mist is collected through negative pressure and flows into the main mist collection pipe 20 that emerges on the underside of air knife 2 on the same side as the front mist collector pipe 22 enters. The main mist collector pipe 20 runs parallel to the wash/rinse stage and ends at the mist collector 11. The middle mist collector pipe 23 extends from the metal lid 75 at opening 76 and connects to the top of middle air knife 4 on the same side as the front mist collector pipe 22. Through negative pressure the mist from the washer unit is drawn into the middle mist collector pipe 23 and runs through the middle air knife 4 and empties into the main mist collector pipe 20. The end mist collector pipe 24 extends from the metal lid 128 through opening 129 and connects to the top of end air knife 6 on the same side as the front mist collector pipe 22. Through negative pressure the mist from the rinse unit is drawn into the end mist collector pipe 24 and runs through the end air knife 6 and empties into the main mist collector pipe 20 that deposits into the mist collector 11.

The mist collector 11, located adjacent to the rinse tank 161 extends perpendicularly and contains an exhaust pipe 21 to vent mist into the atmosphere. The mist collector 11 also has a tank that collects the remaining water/oil mixture and pumps back to the wash tank via pipe (not shown). The unit is utilized to prevent moisture from escaping into the wash area and to provide a recycling apparatus capable of returning liquid back into the system.

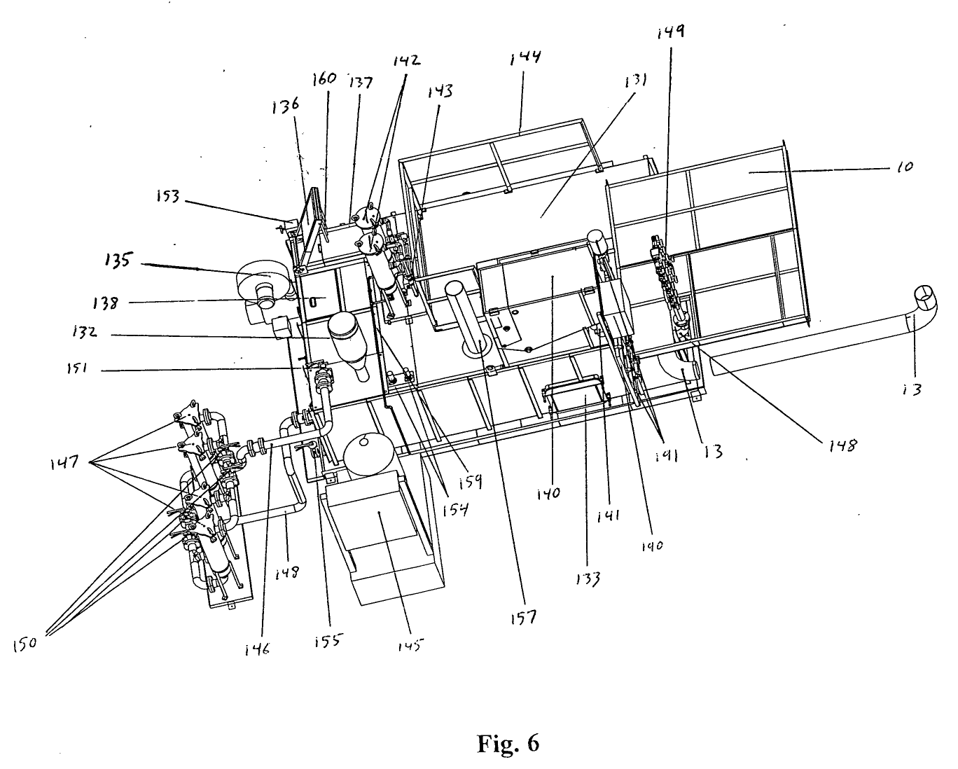

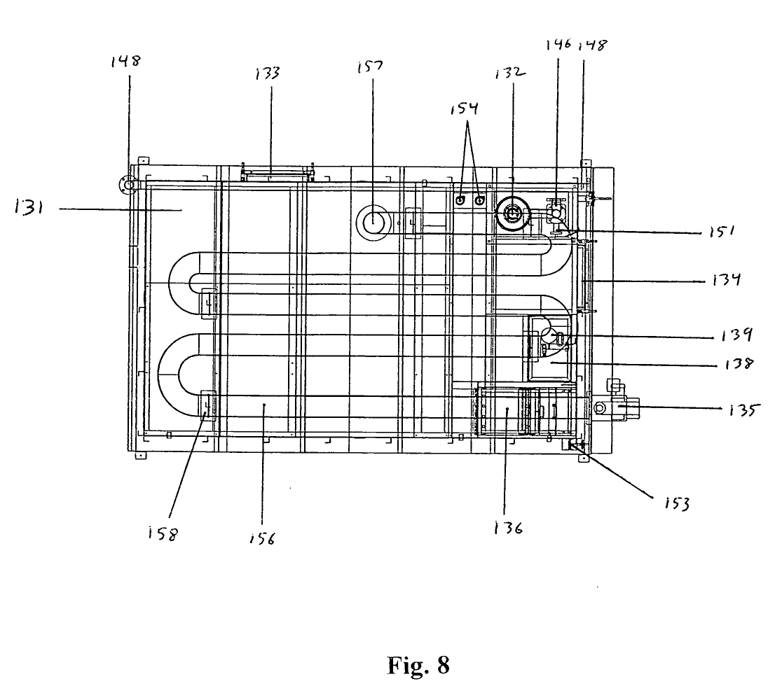

Referring now to FIG. 6, the washer drain pipe 13 connects to the washer drain pan 125 underneath the middle wash cartridges traveling underneath the service platform 10 (shown on FIG. 1) before connecting 14 to the washer tank 131 at the upper corner of the long face of the tank. The metallic washer tank 131 is rectangular in shape with the shorter side of it facing the wash cartridge assemblies. Once inside the wash tank 131, the water from the washer drain pipe 13 flows in a counter clockwise rotation, mixing with tank fluid and passing over the serpentine heating tube 156 (shown on FIG. 8). The end barrel mount water pump 132, mounted on top of the tank, is located on the same side as the washer drain pipe entrance 14 but on the opposite end.

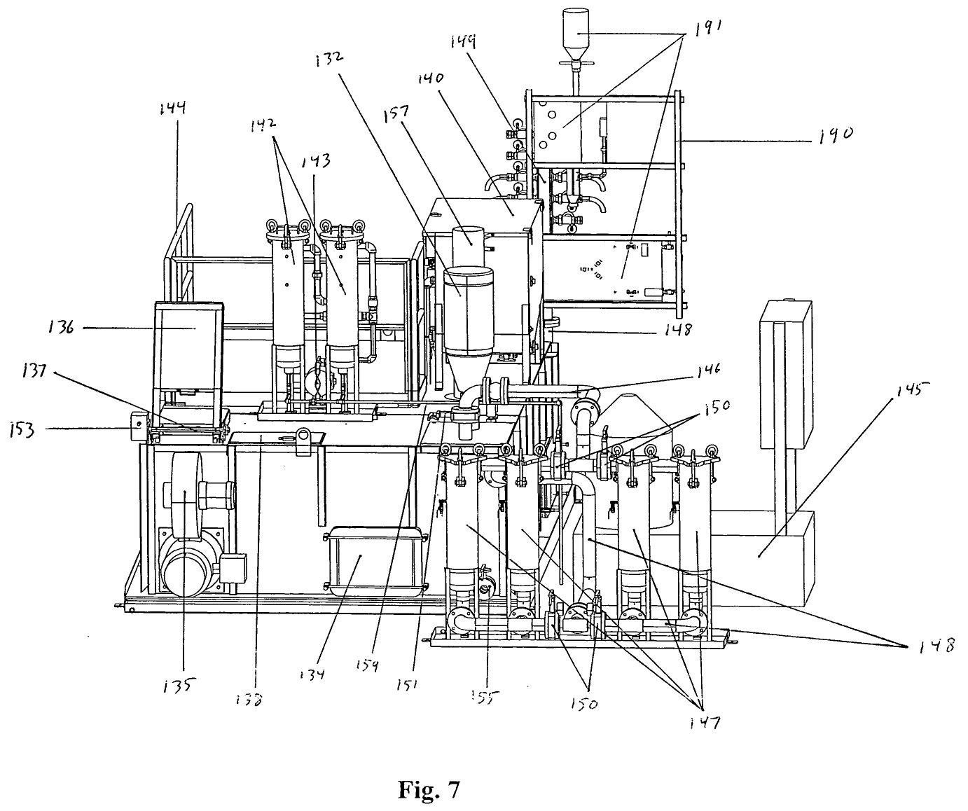

The washer tank 131 contains several exterior features such as two cleanout doors, two top tank access doors and a railing encompassing half of the washer tank excluding the oil separator. The first cleanout door 133 is located on the long face of the washer tank 131 proximal to the water entrance 14. A second cleanout door 134 (shown on FIG. 7) is located at the rear of the wash tank on the short face, adjacent to the tube heating system 135. The two top tank access doors are located in the rear of the washer tank and are positioned next to each other on top of the washer tank 131. The top tank access door 136 at the edge of the washer tank 131 contains a hinged lid complete with frame 137. Four rare Earth magnets 160 are attached to the top tank access door 136. An operator opens the lid by using the manual gear box 153 located adjacent to the top tank access door 136 to open it for cleaning and monitoring of the magnets. When the lid is shut, the magnets are lowered within the wash tank and attract metallic materials. Operators can wipe the magnets down and provide a simple diagnostic test. The middle tank top access door 138 is located adjacent to the first top tank access door 136 and provides access to the oil sucker tube 139 (shown on FIG. 8) that draws oil to the oil decanter 140. The handrail 144 extends along the side of the washer tank on the opposite side of the oil decant separator 140 until approximately half way down the washer tank. From the half way point, the handrail 144 extends along the width of the washer tank before ending at the oil decant separator. The manual drain valve 155 is located at bottom rear of the washer tank on the short face and is used to drain the washer tank. The fluid sensors 154 extend perpendicularly from the tank and are located on the top of the washer tank between the water pump 132 and the exhaust pipe 157. There are two fluid sensors for redundancy and are used to measure the level of fluid in the tank to ensure full capacity at all times.

An oil decant separator unit 140, with a high-temperature pneumatic pump system 141, is mounted along the top of the washer tank 131, situated on the long side just behind the connection 14 of the washer drain pipe 13. The oil separator 140 uses a sucker tube 139 (shown on FIG. 8) located at the top interior of the tank underneath the middle top tank access door 138, to skim oil off the top of the water and remove it from the tank. The water flow in the tank is minimal at the location of the oil skimmer sucker tube 139 and as a result the oil coalesces at that location. The use of the oil separator eases the requirement of the centrifuges to filter out oil by eliminating standing oil in the washer tank.

Mounted externally to the wash tank is an industrial large capacity high-speed centrifuge 145. The centrifuge, utilizing an integral pump, takes water from the side of the wash tank (not shown) and separates the oil from the water. The oil is removed and deposited at a separate location for recycling and the cleaned water, containing approximately 1 percent oil contamination, is returned to the wash tank. Included is an automatic pre-filter package, cleaning pan and its own tank base (not shown).

The barrel mount stainless metal feed stock wet end pump 132 is located at the rear of the wash tank on the same side as the oil separator 140. The pump draws water in from an intake within the washer tank 131 and pumps it through a pipe 146 and into a set of externally mounted filters 147 located behind the wash tank 131. A total of four filters take the piped in water and remove any particles over 40 micron in size. From filter unit 147, the water travels through a pipe 148 that reenters the enclosed washer tank and runs underneath the long side of the wash tank underneath the oil separator before emerging on the opposite end of the wash tank. The pipe 148 emerges from the front of the wash tank 131 and proceeds to a manifold 149 that disperses the heated, cleaned, filtered water to the individual spray headers 37, 61, 73, 88. Butterfly valves 150 are attached at the entrance of the micron filters 147 allowing the water to bypass one micron filter pair. When the micron filter valves are shut off for one pair, the water is piped to the other pair of micron filters. If the manual butterfly valves 150 are not shut off then the wash fluid enters both sets equally. A manual butterfly valve 151 is attached to the water pump allowing the system to be shut off as well as for throttling. A liquid filled pressure gauge is also attached to the water pump (not shown).

Referring now to FIG. 7, two bacteria filters 142 are mounted externally on top of the washer tank 131, approximately in the middle. Using a pneumatic pump 143 the wash liquid is drawn into the first canister that contains an oil absorbing material and then is piped into the second filter which contains a time release chlorine bag that kills any bacteria in the wash fluid. The treated wash water is then piped back into the tank. The removal and prevention of bacteria growth is necessary to prevent clogging of filters, pipes and centrifuges as well to prevent smell and other associated complications of bacteria growth. Emerging from the bottom of the bacteria filters 142 is a drain pipe 159 that extends along the top of the washer tank across its width. After reaching the edge of the washer tank, the drain pipe 159 drops immediately down to a drain along the side of the wash tank. The drain allows for the bacteria filters to be changed or undergo maintenance.

Referring now to FIG. 8, featuring a top-down view of the interior of the wash tank 131, a large serpentine heating tube 156 is contained within the wash tank. It begins in the rear of the wash tank where it is connected to a natural gas burner unit 135 which is mounted externally to the wash tank 131, on the rear short side of the tank. The gas burner unit 135 supplies a heated gas flame through the serpentine heating tube 156 before ending at the exhaust pipe 157. The loops span the width and length of the wash tank. The exhaust pipe 157 is located just behind the oil decant separator and extends perpendicularly out of the washer tank. Multiple support brackets 158 suspend the heating tube within the wash tank, keeping it approximately in the middle of the tank. The serpentine tube carries the flame and heats the water to a predetermined temperature such as 200° F. and maintains the temperature of the water throughout the tank. The heating system also contains a temperature modulator, thermostat control, and a low liquid level safety shut-off switch (not shown).

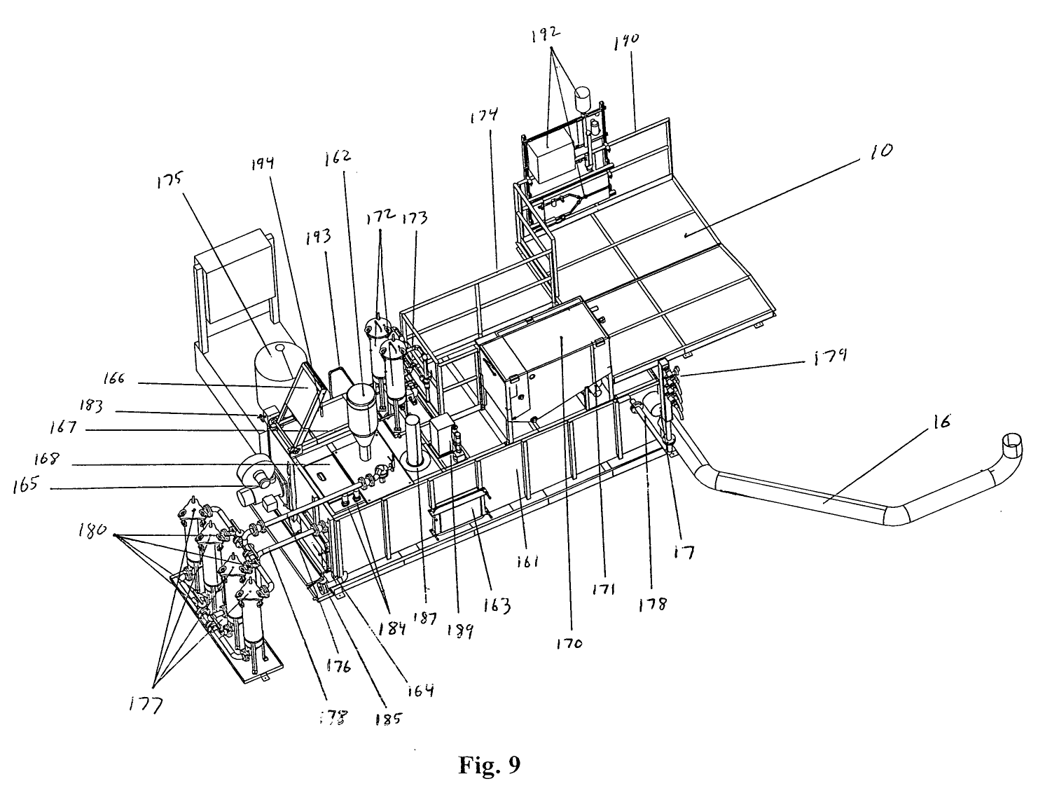

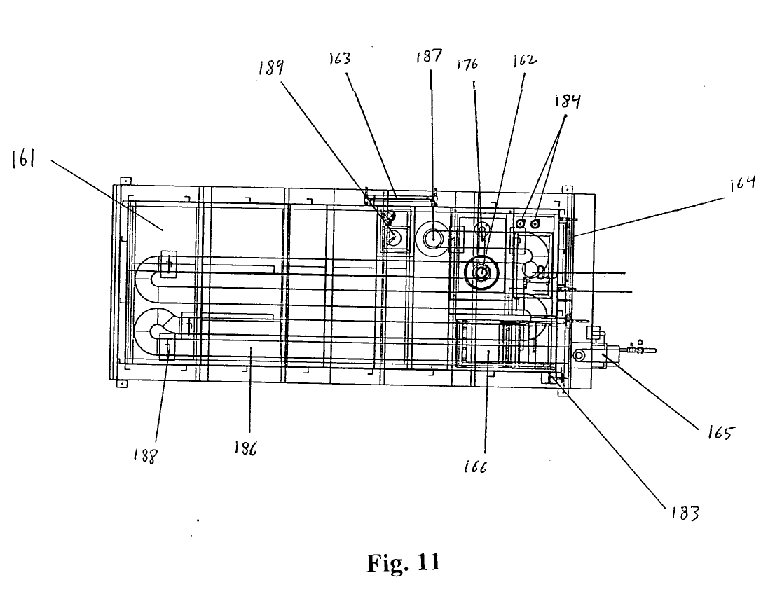

Referring now to FIG. 9, the rinse drain pipe 16 connects to the rinse drain pan 127 underneath the two rinse cartridges traveling underneath the service platform 10 (shown on FIG. 1) before connecting 17 to the rinse tank 161 at the upper corner of the long face of the tank. The metallic rinse tank 161 is rectangular in shape with the shorter side of it facing the rinse cartridge assemblies. Once inside the rinse tank 161, the water from the rinse drain pipe 16 flows in a counter clockwise rotation, mixing with the tank fluid passing over the heated serpentine tube 186 (shown on FIG. 11). The end barrel mount water pump 162, mounted on top of the tank, is located on the same side as the rinse drain pipe entrance 17 but on the opposite end.

The rinse tank 161 contains several exterior features such as two cleanout doors, two top tank access doors and a railing encompassing half of the washer tank excluding the oil separator. The first cleanout door 163 is located on the long face of the rinse tank 161 proximal to the water entrance 17. A second cleanout door 164 is located at the rear of the rinse tank on the short face, adjacent to the tube heating system 165. The two top tank access doors are located in the rear of the rinse tank and are positioned next to each other on top of the rinse tank 161. The top tank access door 166 at the edge of the rinse tank 161 contains a hinged lid complete with frame 167. Four rare Earth magnets 194 are attached to the top tank access door 166. An operator opens the lid by using the manual gear box 183 located adjacent to the top tank access door 166 to open it for cleaning and monitoring of the magnets. When the lid is shut, the magnets are lowered within the wash tank and attract metallic materials. Operators can wipe the magnets down and provide a simple diagnostic test. The middle tank top access 168 door located in the middle provides access to the oil sucker tube 169 (shown on FIG. 8) that draws oil to the oil decanter 170. The handrail 174 extends along the side of the rinse tank on the opposite side of the oil decant separator 170 until approximately half way down the rinse tank. From the half way point, the handrail 144 extends along the width of the rinse tank before ending at the oil decant separator. The manual drain valve 185 is located at bottom rear of the rinse tank on the short face. The fluid sensors 184 extend perpendicularly from the rinse tank 161 and are located on the top of the rinse tank between the water pump 162 and the exhaust pipe 187. There are two fluid sensors for redundancy and are used to measure the level of fluid in the tank to ensure full capacity at all times.

An oil decant separator unit 170, with a high-temperature pneumatic pump system 171, is mounted along the top of the rinse tank 161, situated on the long side just behind the connection of the rinse drain pipe 16. The oil separator 170 uses a sucker tube 169 (shown on FIG. 11) located at the top interior of the tank underneath the middle top tank access door 168, to skim oil off the top of the water and remove it from the tank. The water flow in the tank is minimal at the location of the oil skimmer sucker tube 169 and as a result the oil coalesces at that location. The use of the oil separator eases the requirement of the centrifuges to filter out oil by eliminating standing oil in the rinse tank.

Mounted externally to the rinse tank is an industrial large capacity high-speed centrifuge 175. The centrifuge, utilizing an integral pump, takes water from the rinse tank and separates the oil from the water. The oil is removed and deposited at a separate location for recycling and the cleaned water, containing approximately 1/10th percent oil contamination, is returned to the rinse tank. Included is an automatic pre-filter package, cleaning pan and its own tank base (not shown).

The barrel mount stainless metal feed stock wet end pump 162 is located at the rear of the rinse tank on the same side as the oil separator 170. The pump draws water in from an intake within the rinse tank 161 and pumps it through a pipe 176 and into a set of externally mounted filters 177 located behind the rinse tank 161. A total of four filters take the piped in water and remove any particles over 40 micron in size. From the filter unit 177, the water travels through a pipe 178 that reenters the enclosed rinse tank and runs underneath the long side of the rinse tank underneath the oil separator before emerging on the opposite end of the rinse tank. The pipe 178 emerges from the front of the rinse tank 161 and proceeds to a manifold 179 that disperses the heated, cleaned, filtered water to the individual spray headers 100, 113. Butterfly valves 180 are attached at the entrance of the micron filters 177 allowing the water to bypass one micron filter pair. When the micron filter valves are shut off for one pair, the water is piped to the other pair of micron filters. If the manual butterfly valves 180 are not shut off then the wash fluid enters both sets equally. A manual butterfly valve 181 is attached to the water pump allowing the system to be shut off as well as for throttling. A liquid filled pressure gauge is also attached to the water pump (not shown).

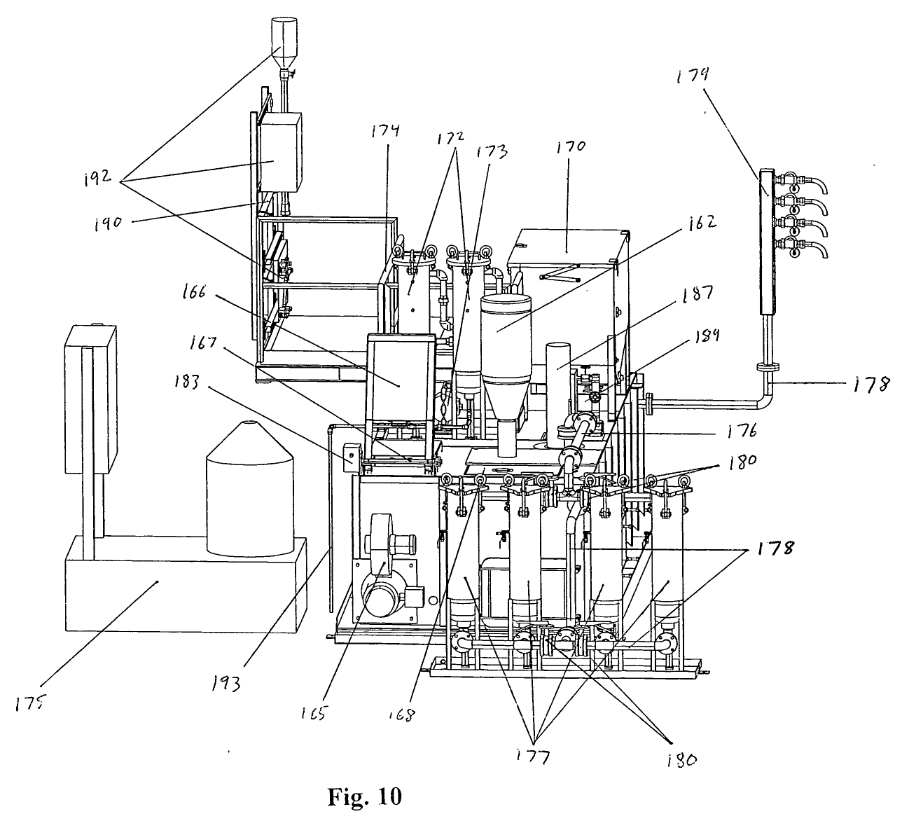

Referring now to FIG. 10, two bacteria filters 172 are mounted externally on top of the rinse tank 161, approximately in the middle. Using a pneumatic pump 173 the wash liquid is drawn into the first canister that contains an oil absorbing material and then is piped into the second filter which contains a time release chlorine bag that kills any bacteria in the rinse fluid. The treated rinse water is then piped back into the tank. The removal and prevention of bacteria growth is necessary to prevent clogging of filters, pipes and centrifuges as well to prevent smell and other associated complications of bacteria growth. Emerging from the bottom of the bacteria filters 172 is a drain pipe 193 that extends along the top of the rinse tank across its width. After reaching the edge of the washer tank, the drain pipe 193 drops immediately down to a drain along the side of the rinse tank. The drain allows for the bacteria filters to be changed or undergo maintenance.

Referring now to FIG. 11, featuring a top-down view of the interior of the rinse tank 161, a large serpentine heating tube 186 is contained within the rinse tank. It begins in the rear of the rinse tank where it is connected to a natural gas burner unit 165. The natural gas burner unit 165 is mounted externally to the rinse tank 161, on the rear short side of the tank. The gas burner unit 165 supplies a heated gas through the serpentine heating tube 186 before ending at the exhaust pipe 187. The loops span the width and length of the rinse tank. The exhaust pipe 187 is located just behind the oil decant separator and extends perpendicularly out of the rinse tank. Multiple support brackets 188 suspend the heating tube within the rinse tank, keeping it approximately in the middle of the tank. The serpentine tube carries the heated gas and heats the water to a predetermined temperature such as 160° F. and maintains the temperature of the water throughout the tank. The heating system also contains a temperature modulator, thermostat control, and a low liquid level safety shut-off switch (not shown).

The rinse tank contains a refill line 189 that draws in osmosis water to replace any liquid lost due to evaporation. The tank refill line 189 controls the osmosis fluid and automatically replaces lost water to the capacity of the rinse tank 161 of approximately 1500 gallons. The tank refill line 189 is located in between the oil decanter 170 and the exhaust pipe 187 and extends perpendicular from the rinse tank. A pneumatic pump pumps rinse water to the wash tank to refill it (not shown). The fluid sensors 184 on the rinse tank and the fluid sensors 154 on the wash tank determine the amount of water needed for each tank. The wash tank includes an osmosis system that draws water from the rinse tank into the wash tank to replenish water that has evaporated or been lost (not shown). The wash tank 131 capacity is approximately 2500 gallons.

Before concluding, it is to be understood that the terminology employed in this application is for the purpose of describing particular embodiments. Unless the context clearly demonstrates otherwise, it is not intended to be limiting. In this specification and the appended claims, the singular forms “a,” “an” and “the” include plural references unless the context clearly dictates otherwise. Conversely, it is contemplated that the claims may be drafted to exclude any optional element or be further limited using exclusive terminology as “solely,” “only” and the like in connection with the recitation of claim elements or by use of a “negative” limitation. It is also contemplated that any optional feature of the inventive variations described herein may be set forth and claimed independently, or in combination with any one or more of the features described herein.

Although the foregoing specific details describe various embodiments of the invention, persons reasonably skilled in the art will recognize that various changes may be made in the details of the apparatus of this invention without departing from the spirit and scope of the invention as defined in the appended claims. Therefore, it should be understood that, unless otherwise specified, this invention is not to be limited to the specific details shown and described herein.

We claim:

1. A method of cleaning coated metal feed stock with a multi-stage washer comprising the steps of:
running a metal feed stock through a series of wash, rinse and drying stages to clean the surface of the metal feed stock with wash and rinse waters;
cleaning the metal feed stock with abrasive rolls;
removing the coating on the flat sheet metal with the wash and rinse waters and abrasive rolls so the flat sheet metal can be further processed;
separating the wash and drying stages with air knives to reduce cross contamination between the wash and rinse waters;
removing water on the surface of the flat metal feed stock with a heated blow dry.
separating the removed coating from the wash and rinse waters using a centrifuge so the wash and rinse waters can be recycled and the removed coating can be disposed of

2. The method of claim 1 and further comprising the step of:
heating the wash water to assist in cleaning.

3. The method of claim 1 and further comprising the step of:
heating the rinse water to assist in cleaning.

4. The method of claim 1 and further comprising the step of:
monitoring the water for oil and carbon impurities and maintaining specified levels in the water.

5. The method of claim 1 and further comprising the step of:
containing mist and steam from escaping the wash, rinse and drying stages.

6. The method of claim 1 and further comprising the step of:
maintaining separate wash and rinse water tanks at specified levels of contamination.

7. The method of claim 1 and further comprising the step of:
removing metallic impurities in the wash and rinse water with magnets.

8. The method of claim 1 and further comprising the step of:
removing pre-determined amounts of oil and debris from the coating on the metal feed stock by washing with hot water at a pre-determined temperature and pressure.

9. The method of claim 1 and further comprising the step of:
filtering the hot water to remove oil and impurities.

10. The method of claim 1 and further comprising the step of:
separating any oil and impurities from the wash water for recycling and monitoring the cleanliness of the hot wash water and recycling it into the system.

11. A multi-stage coil washer for cleaning coated metal feed stock comprising:
a series of wash, rinse and drying stations for cleaning the surface of the flat metal feed stock of a coating;
said wash and rinse stations having a water wash and rinse for removing the coating on the flat sheet metal so it can be processed into finished products so the flat metal feed stock can be further processed;
said wash station having abrasive rolls to further clean the metal feed stock;
air knives separating the wash, rinse and dry stages to reduce cross contamination between the wash and rinse waters;
at least one centrifuge for removing the coating from the wash and rinse waters so the wash and rinse water can be recycled and the removed coating can be disposed of

12. The multi-stage coil washer as claimed in claim 11 further comprising:
a water heater to heat the wash water to improve cleaning.

13. The multi-stage coil washer as claimed in claim 11 further comprising:
a water heater to heat the rinse water to improve cleaning.

14. The multi-stage coil washer as claimed in claim 11 further comprising:
a modular heated blow dry stage.

15. The multi-stage coil washer as claimed in claim 11 further comprising:
a modular mist containment stage.

16. The multi-stage coil washer as claimed in claim 11 further comprising:
a modular filtration stage.

17. The multi-stage coil washer as claimed in claim 11 further comprising:
the wash and rinse units include individually motor driven rolls on the wash and rinse stations.

18. The multi-stage coil washer as claimed in claim 11 further comprising:
the wash and rinse stations including modularly constructed cartridges to allow for easy removal, replacement, or maintenance.

19. The multi-stage coil washer as claimed in claim 11 further comprising:
a mist containment unit including air knives prevent mist and steam from escaping the wash, rinse and dry stations.

20. The multi-stage coil washer as claimed in claim 11 further comprising:
a piping system that utilizes negative pressure to capture mist and steam and direct it to a centralized mist collector;
a mist collector that vents evaporated water into the atmosphere; and
a piping system that returns water collected by the mist collector back into the rinse system.

21. A coated metal feed stock cleaner with a multi-stage coil washer for cleaning coated metal feed stock comprising:
a frame means for removably mounting wash, rinse and dry stages for cleaning coated metal feed stock with heated water;
a modular wash cartridge in the wash stage that is removably mounted on the frame so that the cartridge can be removed and quickly replaced with a new cartridge; and
a modular rinse cartridge in the rinse stage that removably mounted on the frame so that the cartridge can be removed and quickly replaced with a new cartridge.

22. The multi-stage coil washer as claimed in claim 21 further comprising:
a modular heated blow dry stage.

23. The multi-stage coil washer as claimed in claim 21 further comprising:
a modular mist containment stage.

24. The multi-stage coil washer as claimed in claim 21 further comprising:
a modular filtration stage.

25. The multi-stage coil washer as claimed in claim 21 further comprising:
the wash and rinse units include individually motor driven rolls.

26. The multi-stage coil washer as claimed in claim 21 further comprising:
the wash and rinse units include modularly constructed cartridges to allow for easy removal, replacement, or maintenance.

27. The multi-stage coil washer as claimed in claim 21 further comprising:
a set of air knives to prevent contamination between wash and rinse water.

28. The multi-stage coil washer as claimed in claim 21 further comprising:
a mist containment unit including air knives to prevent mist and steam from escaping the wash, rinse and dry stations.

29. The multi-stage coil washer as claimed in claim 21 further comprising:
a piping system that utilizes negative pressure to capture mist and steam and direct it to a centralized mist collector;
a mist collector that vents evaporated water into the atmosphere; and
a piping system that returns water collected by the mist collector back into the rinse system.
